(19) United States
(12) Patent Application Publication
(10) Pub. No.: US 2008/0295341 A1
(43) Pub. Date: Dec. 4, 2008

(54) Hand operated cutting tool

(75) Inventors: Daniel J. Lipscomb, Prairie du Sac, WI (US); Jason Crowell, Madison, WI (US)

Correspondence Address: FOLEY & LARDNER LLP, 777 EAST WISCONSIN AVENUE, MILWAUKEE, WI, 53202-5306, US

(73) Assignee: Fiskars Brands, Inc.

(21) Appl. No.: 11/809,991

(22) Filed: Jun. 4, 2007

(51) Int. Cl. B26B 13/00

(52) U.S. Cl. 30/251

(57) ABSTRACT

A hand-operated cutting tool includes a first and second handles, with first ends of the handles pivotally coupled together to form a first pivot point. The tool also includes first and second elongated members each having a first end and a second end and an intermediate region therebetween, the second ends having a cutting jaw. A second pivot point couples the intermediate regions of the elongated members to one another. A third pivot point couples the first end of the first elongated member to the first handle. A fourth pivot point couples the first end of the second elongated member to the second handle, so that the handles and the elongated members and the pivot points cooperate as a four-bar linkage for movement of the cutting jaws between an open position and a closed position.

### FIELD

The present invention relates to a hand-operated cutting tool. The present invention relates more particularly to a hand-operated cutting tool, such as a pruner, or a pair of snips or shears, having a rear pivot joint for actuating the cutting jaws of the tool.

### BACKGROUND

It is generally known to provide a hand-operated tool such as a snips, shears, scissors or the like having a pair of pivoting members with sharpened edges that slide past one another to cut an object placed between the sharpened edges. However, such known tools typically have handles arranged to pivot at a forward or intermediate location for actuating the cutting jaws of the tool, with the rear (open) ends of the handles unattached to one another so that a user may grip and squeeze the rear ends together to actuate the cutting jaws. Such known tools tend to have the disadvantage that the stronger fingers of a user's hand (typically the first two fingers) are arranged to grip the handle near the pivot point and away from open ends (where maximum leverage in such tools is often generated).

Accordingly, it would be desirable to provide a hand-operated cutting tool, such as a pruner or pair of snips, having a pair of pivotally connected handles with a rear pivot point and an “open” end near the front of the tool. It would also be desirable to provide a hand-operated cutting tool having a pair of pivotally interconnected cutting jaws that are also connected near the open front of the handles. It would also be desirable to provide a hand-operated cutting tool where the handles and the cutting jaws are connected for operation as a four-bar linkage. It would also be desirable to provide a hand-operated cutting tool that is spring-biased toward an open position for ease of use in multiple cutting operations. It would also be desirable to provide a hand-operated cutting tool that includes a lock device for maintaining the blades in a closed position. It would further be desirable to provide a hand operated cutting tool having handles shaped or contoured to provide an ergonomic design.

Accordingly, it would be desirable to provide a hand-operated cutting tool having any one or more of these or other desirable features.

### SUMMARY

According to one embodiment, a hand-operated cutting tool includes a first handle and a second handle each having a first end and a second end. A first pivot connection couples the first ends of the handles for movement of the handles relative to one another between an open position and a closed position. The tool also includes a first elongated member and a second elongated member each having a pivot end and a jaw end and an intermediate region therebetween, with the pivot end of the first elongated member pivotally coupled near the second end of the first handle and the pivot end of the second elongated member pivotally coupled near the second end of the second handle. A second pivot connection couples the intermediate regions of the elongated members for movement of the elongated members relative to one another.

According to another embodiment, a hand-operated cutting tool includes a first handle and a second handle each having a first end and a second end, with the first ends pivotally coupled together to form a first pivot point. The tool also includes a first elongated member and a second elongated member each having a first end and a second end and an intermediate region therebetween, with the second ends comprising a cutting jaw. A second pivot point couples the intermediate regions of the elongated members to one another. A third pivot point couples the first end of the first elongated member to the first handle and a fourth pivot point couples the first end of the second elongated member to the second handle, so that the handles and the elongated members and the pivot points cooperate as a four-bar linkage for movement of the cutting jaws between an open position and a closed position.

According to a further embodiment, a hand-operated cutting tool includes a first handle and a second handle each having a first end and a second end with a first connection pivotally coupling the first ends of the handles for movement of the handles between an open position and a closed position. The tool also includes a first elongated member and a second elongated member each having a handle end and a cutting end and an intermediate region therebetween, with the handle end of the first elongated member coupled to the first handle and the handle end of the second elongated member coupled to the second handle A second connection pivotally couples the intermediate regions of the elongated members for movement of the cutting ends between an open position and a closed position as the handles are moved between the open position and the closed position.

### BRIEF DESCRIPTION OF THE DRAWINGS

FIG. 1 is a schematic image of a front perspective view of a hand-operated cutting tool according to an exemplary embodiment.

FIG. 2 is a schematic image of a rear perspective view of a hand-operated cutting tool according to the embodiment of FIG. 1.

FIG. 3 is a schematic image of a rear elevation view of a hand-operated cutting tool according the embodiment of FIG. 1.

FIG. 4 is a schematic image of a cross sectional rear elevation view of a hand-operated cutting tool according the embodiment of FIG. 1.

FIG. 5 is a schematic image of a rear perspective view of a hand-operated cutting tool according to another exemplary embodiment.

FIG. 6 is a schematic image of a rear perspective view of a hand-operated cutting tool according to another exemplary embodiment.

### DETAILED DESCRIPTION

Referring to the FIGURES, a hand-operated cutting tool, shown for example as a pruner, or pair of snips or shears is shown according to an exemplary embodiment. The tool is shown to include a pair of handles and a pair of elongated members that are connected together in a four-bar linkage arrangement according to the illustrated embodiment. The handles are pivotally connected to each other at a rear end of the tool, and are each pivotally connected to a rear end of one of the elongated members near a front end of the tool. The elongated members are pivotally connected at an intermediate location so that the front ends of the elongated members (shown to include cutting jaws) are opened and closed in a cutting operation as the front ends of the handles are opened and closed (i.e. moved away and toward one another respectively). The handles are shown to include ergonomically contoured surfaces, to minimize user-fatigue during extended use of the tool. The tool is also shown to include a spring that biases the front ends of the handles toward the open position (i.e. to open the cutting jaw) to automatically open (or assist in opening) the jaws following completion of a cutting operation. A lock device is also provided to lock the handles in a closed position when the tool is not in use. The locking device is actuatable between a “locked” position to maintain the cutting jaws in the closed position and a “use” position to permit the cutting jaws to be opened (e.g. spring-biased or “sprung-open”).

Accordingly, the tool can be used to cut a wide variety of objects between the cutting jaws, by gripping and squeezing the handles with the (typically) stronger first several fingers of a user's hand located near the open (i.e. front) end of the handles. It should be noted that the connection between the handles and the elongated members may be a pivot connection (as shown in the Figures), but may also include other types of connections to permit enhanced leverage to be applied to the cutting jaws. For example, a sliding connection may be provided for a lever device, or a surface having projections may be provided for a gear device, etc. In addition, the lock device may operate in any suitable manner (e.g. slide, push-pull, lever, etc.). Further, the cutting jaw portion of one of the elongated members may be provided in the form of blades to permit operation of the tool in the manner of a shears, snips, scissors, etc., but may also include a generally planar surface arranged to bear against the sharpened internal edge of the other blade portion (e.g. in an anvil-like manner), or may be provided with a hook arranged to slide past an opposing blade during the cutting operation (e.g. in the manner of a “bypass” type pruner, etc.). Accordingly, the embodiments illustrated in the FIGURES are shown by way of example, and any of a wide variety of blades, handles, and connection styles or shapes, and combinations thereof, will be readily apparent to a person of ordinary skill in the art after reviewing this disclosure. All such variations are intended to be within the scope of the invention.

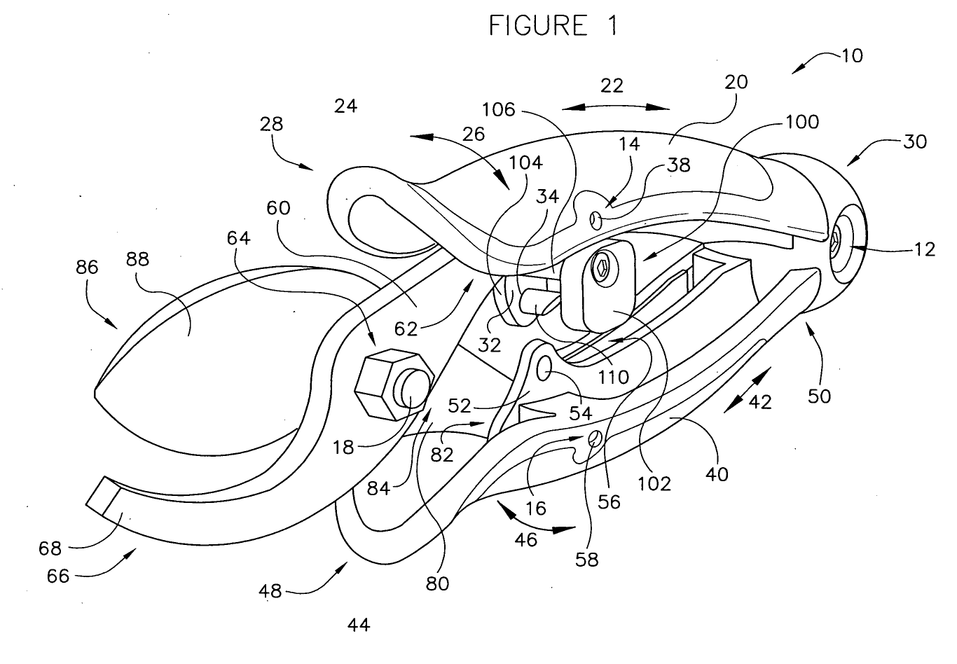

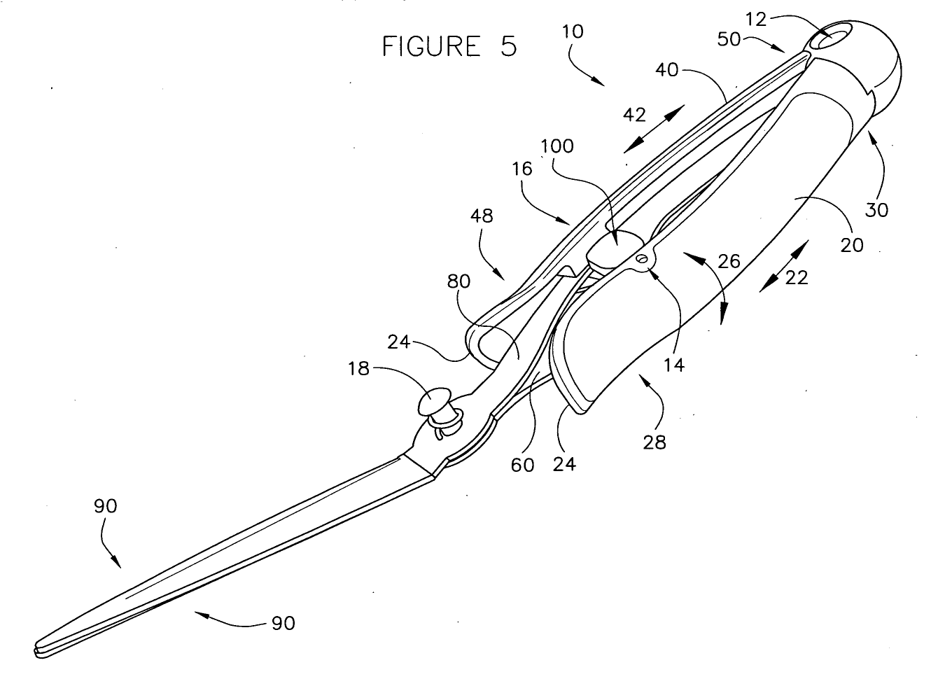

Referring to FIGS. 1-6, a hand-operated cutting tool 10 (shown for example as a “pruner” in FIGS. 1-4 and 6 and as a snips in FIG. 5) is shown according to one embodiment. Tool 10 includes a first handle 20 and a second handle 40 (e.g. a pair of handles), and a first elongated member 60 and a second elongated member 80 (e.g. a pair of elongated members).

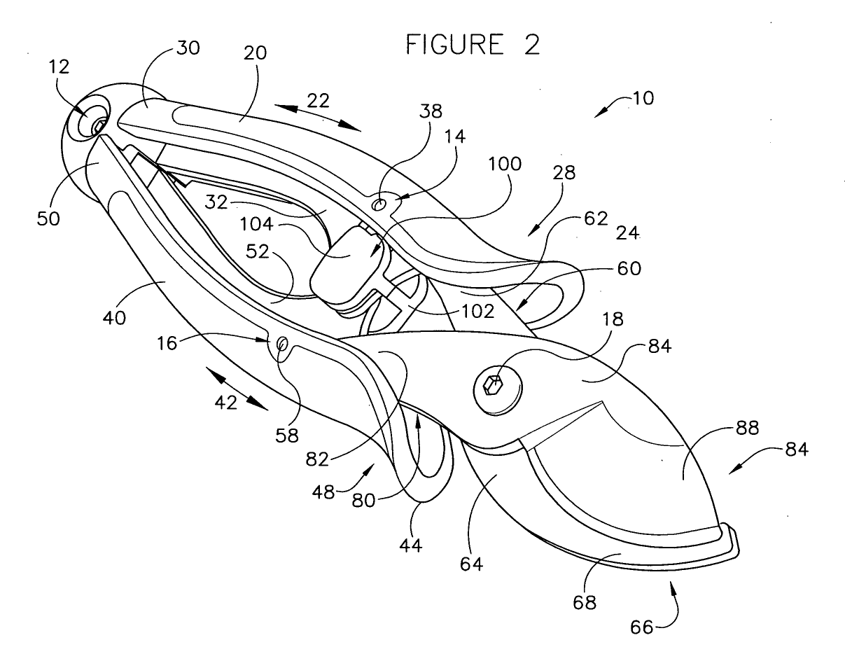

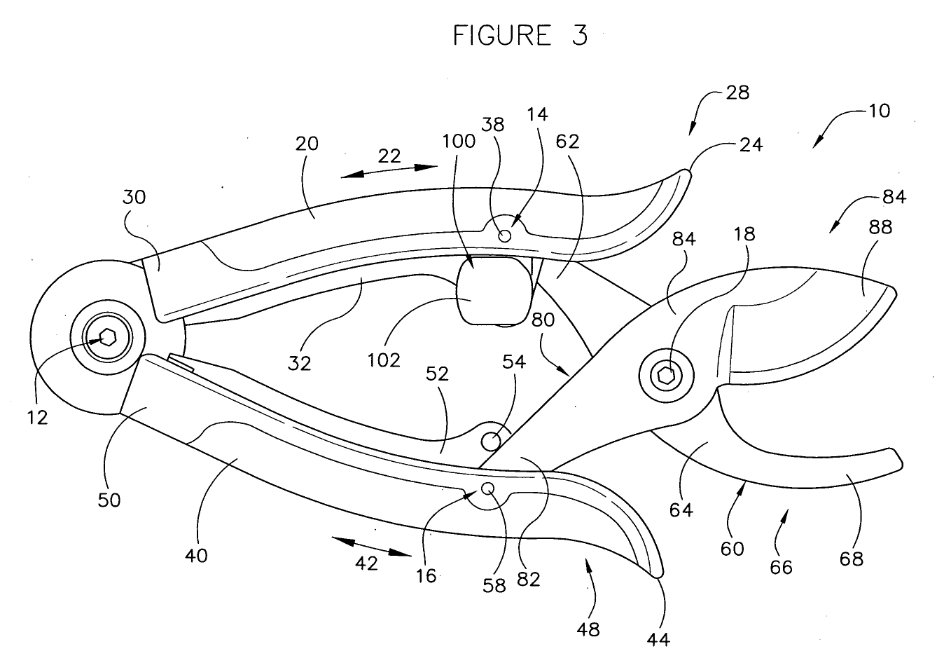

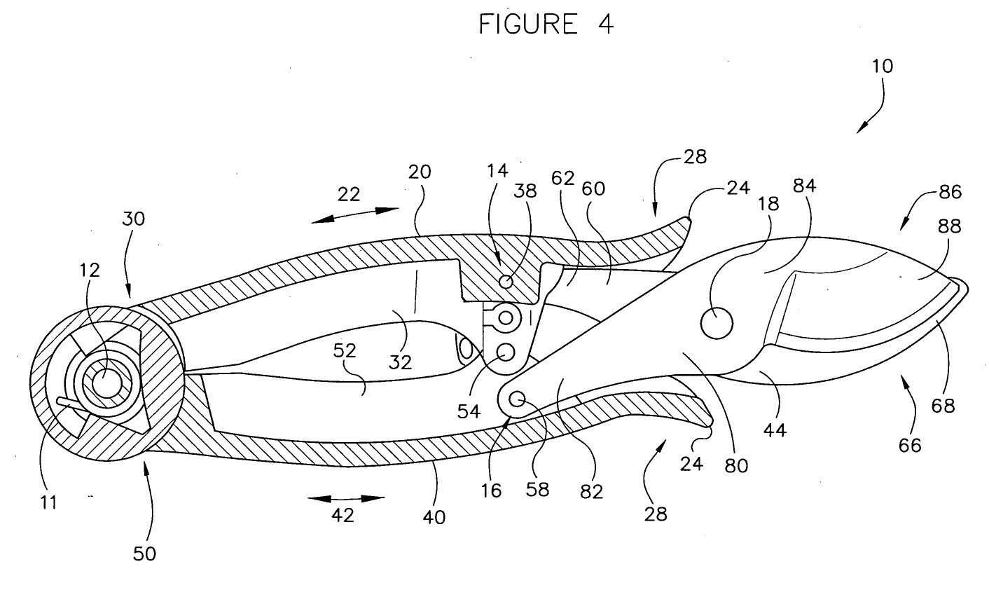

The handles 20, 40 are shown having an ergonomic shape adapted to fit a palm of user's hand in a comfortable grip, and include a longitudinal convex profile 22, 42 with a forward lip 24, 44, and a transverse convex profile 26, 46. The handles 20, 40 include a first end (shown as a “front” end 28, 48) and a second end (shown as a “rear” end 30, 50). The rear ends 30, 50 of the handles 20, 40 are coupled together by a pivot-type connection 12 (e.g. with a pin, sleeve, bushing, etc.) for pivotal movement of the front ends 28, 48 of the handles 20, 40 between an open position (as shown in FIGS. 1 and 3) and a closed position (as shown in FIGS. 2 and 4). A spring 11 (shown for example as a coil type spring in FIG. 4) is provided about the connection 12 to bias the front of the handles toward the open position. According to alternative embodiments, any suitable type of spring at any appropriate location on the handles may be provided to bias the front of the handles to the open position.

Handles 20, 40 are also shown to include an internal rib 32, 52 having an aperture 34, 54 arranged so that the apertures 34, 54 are axially aligned when the front of the handles are in the closed position. A lock device 100 (shown for example as a slide-type lock device) is provided with opposed engagement surfaces 102, 104. A link 106 interconnects the engagement surfaces 102, 104 and extends through an aperture 108 in the rib of one of the handles. One of the engagement surfaces also includes a projection (shown as a pin or peg 110) that is configured to engage both apertures 34, 54 when the front of the handles are moved to the closed position (to align the apertures) and a force is applied to one of the engagement surfaces to shift peg 110 in a transverse direction to enter the apertures and actuate the lock device. In order to disengage the lock device, a force is applied to the opposite engagement surface to shift the peg 110 in an opposite transverse direction to withdraw the peg from one or both apertures 34, 54. Handles 20, 40 are further shown to include receptacles 36, 56 and pins 38, 58 near the front ends 28, 48 to receive and establish a pivot connection 14, 16 with an end of the elongated members 60, 80.

Referring further to FIGS. 1-4, the elongated members 60, 80 are shown to include first end (shown as a pivot end 62, 82) that are coupled to the handles at the pivot connections 14, 16. Elongated members 60, 80 also include an intermediate region 64, 84 that are coupled together by a pivot connection 18 (shown for example as a threaded fastener, which may include a bushing of the like). Elongated members 60, 80 are further shown to include a second end having forwardly extending cutting jaws 66, 86. The handles 20, 40 and the portion of the elongated members 60, 80 between the pivot ends 62, 82 and the intermediate regions 64, 84, and the pivot connections 12, 14, 16, 18, operate as a four-bar type linkage so that when the front of the handles are moved between the open position and the closed position, the cutting jaws 66, 86 are pivotally actuated about pivot connection 18 between an open position and a closed position to perform a cutting operation.

The relative dimensions of the handle portions and the elongated member portions that constitute the four-bar linkage may be arranged to provide any desired amount of mechanical advantage, corresponding to the type of objects intended (or desired) to be cut by the cutting jaws. For example, the handle portions may have a length that is greater than the length of the portions of the elongated members (as shown by way of example in the FIGURES). Alternatively, the handle portions may have a length that is less than the length of the portions of the elongated members, or the handle portions and the elongated member portions may have lengths that are substantially equal. According to a further alternative embodiment, one or both of the handle front pivot connections may be replaced with other types of connections that may be desirable for providing a tool with a greater mechanical advantage at the cutting jaws. For example, an additional link with a sliding connection may be provided, or a pair of gear segments may be provided to transfer and amplify a closing force from the handles to the cutting jaws.

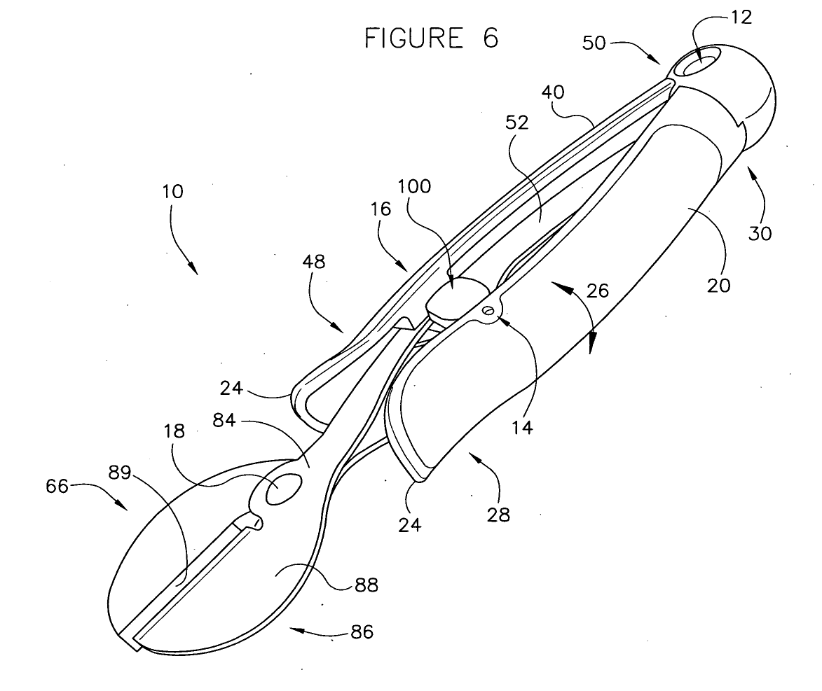

The cutting jaws 66, 86 of the present embodiment are shown by way of example in FIGS. 1-4 to include a blade 88 and a hook 68, arranged so that the hook operates to capture an object to be cut, while the blade 88 slides past the hook 68 as the handles are moved toward the closed position, to effect a cutting operation (e.g. in the manner of a “bypass” pruner or the like). The cutting jaws are also shown by way of example in FIG. 5 to include a pair of blades 90, arranged so that the blades slide past one another as the handles are moved toward the closed position, to effect a operation (e.g. in the manner of a snips, shears, scissors, or the like). According to an alternative embodiment, the cutting jaws may have other characteristics intended to accomplish any desired type of cutting operation. For example, one of the cutting jaws may be provided with generally flat surface 89 intended to abut against the edge of an opposing blade as the handles are moved toward the closed position to crush/cut an object between the blade and the surface (e.g. in the manner of an “anvil” type pruner or the like—shown by way of Example in FIG. 6).

According to any exemplary embodiment, the hand-operated cutting tool provides a tool having a pair of handles that are pivotally connected to one another at a rear end of the handles for opposing movement of the front ends of the handles (e.g. expansion-contraction, etc.) between an open position and a closed position. Elongated members with mid-portions pivotally connected to one another each have one end pivotally connected to the front end of a corresponding handles to create a four bar linkage. An opposite end of the elongated members project forwardly to form a pair of cutting jaws that are opened and closed as the handles are opened and closed to perform a cutting operation. Placement of the pivot connection for the handles at a rear end of the handles is intended to permit the stronger portion of a user's hand to generally coincide with the portion of the handles having the greatest range of motion, to provide an increased force at the cutting jaws.

According to other alternative embodiments, the tool may be provided with, or without, a lock device (for maintaining the handles in a closed position) and/or a spring-assist (for biasing the cutting jaws and handles to an open position). The elongated members may be formed from any material suitable for the application, such as steel. The handles may be made from a material such as (among others) glass-filled nylon, die-cast zinc, or plastic, in a molding or other suitable process.

It is also important to note that the construction and arrangement of the elements of the hand-operated cutting tool as shown schematically in the embodiments is illustrative only. Although only a few embodiments have been described in detail in this disclosure, those skilled in the art who review this disclosure will readily appreciate that many modifications are possible without materially departing from the novel teachings and advantages of the subject matter recited.

Accordingly, all such modifications are intended to be included within the scope of the present invention. Other substitutions, modifications, changes and omissions may be made in the design, operating conditions and arrangement of the preferred and other exemplary embodiments without departing from the spirit of the present invention.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the present invention as expressed in the appended claims.

What is claimed is:

1. A hand-operated cutting tool, comprising:
a first handle and a second handle each having a first end and a second end;
a first pivot connection coupling the first ends of the handles for movement of the handles relative to one another between an open position and a closed position;
a first elongated member and a second elongated member each having a pivot end and a jaw end and an intermediate region therebetween, the pivot end of the first elongated member pivotally coupled proximate the second end of the first handle and the pivot end of the second elongated member pivotally coupled proximate the second end of the second handle; and
a second pivot connection coupling the intermediate regions of the elongated members for movement of the elongated members relative to one another.

2. The tool of claim 1 wherein movement of the handles from the open position to the closed position results in movement of the jaws in a cutting operation.

3. The tool of claim 1 further comprising a spring biasing the handles toward an open position.

4. The tool of claim 1 further comprising a lock device to maintain the handles in the closed position.

5. The tool of claim 4 wherein the lock device comprises a slidable post operable to engage an aperture on at least one of the handles.

6. The tool of claim 1 wherein the jaw end of each elongated member comprises a cutting blade.

7. The tool of claim 1 wherein one of the jaw ends comprises a hook configured to capture an object to be cut by the other jaw end.

8. A hand-operated cutting tool, comprising:
a first handle and a second handle each having a first end and a second end, the first ends pivotally coupled together to form a first pivot point;
a first elongated member and a second elongated member each having a first end and a second end and an intermediate region therebetween, the second ends comprising a cutting jaw;
a second pivot point coupling the intermediate regions of the elongated members to one another;
a third pivot point coupling the first end of the first elongated member to the first handle;
a fourth pivot point coupling the first end of the second elongated member to the second handle;
wherein the handles and the elongated members and the pivot points cooperate as a four-bar linkage for movement of the cutting jaws between an open position and a closed position.

9. The tool of claim 8 further comprising a spring operable to bias the third pivot point and the fourth pivot point away from one another for movement of the jaws to an open position.

10. The tool of claim 8 wherein the third pivot point is located proximate the second end of the first handle and the fourth pivot point is located proximate the second end of the second handle.

11. The tool of claim 8 wherein a distance between the first pivot point and the third pivot point is greater than a distance between the second pivot point and the third pivot point.

12. The tool of claim 8 further comprising a lock device having a slidable post operable to engage an aperture on at least one of the handles.

13. The tool of claim 8 wherein at least one of the cutting jaws comprises a sharpened blade.

14. The tool of claim 8 wherein one of the cutting jaws comprises a curved hook.

15. A hand-operated cutting tool, comprising:
a first handle and a second handle each having a first end and a second end;
a first connection pivotally coupling the first ends of the handles for movement of the handles between an open position and a closed position;
a first elongated member and a second elongated member each having a handle end and a cutting end and an intermediate region therebetween, the handle end of the first elongated member coupled to the first handle and the handle end of the second elongated member coupled to the second handle; and
a second connection pivotally coupling the intermediate regions of the elongated members for movement of the cutting ends between an open position and a closed position as the handles are moved between the open position and the closed position.

16. The tool of claim 15 wherein the first elongated member is pivotally coupled to the first handle at a third connection and the second elongated member is pivotally coupled to the second handle at a fourth connection.

17. The tool of claim 15 wherein the elongated members and the handles and the connections operate as a four-bar linkage for movement of the handles and the cutting ends between the open position and the closed position.

18. The tool of claim 15 further comprising a spring operable to bias the third connection and the fourth connection away from one another for movement of the cutting ends to an open position.

19. The tool of claim 15 further comprising a lock device having a slidable post operable to engage an aperture on at least one of the handles.

20. The tool of claim 15 wherein at least one of the cutting ends comprises a sharpened blade.

21. The tool of claim 15 wherein one of the cutting ends comprises a curved hook.
